(19) United States
(12) Patent Application Publication
(10) Pub. No.: US 2003/0227921 A1
(43) Pub. Date: Dec. 11, 2003

(54) System and method for controlling data call traffic frame in mobile communication system

(75) Inventor: Sang-Yong Jeon, Gyunggi-Do (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/456,912

(22) Filed: Jun. 9, 2003

(30) Foreign Application Priority Data
Jun. 11, 2002 (KR) 32460/2002

(51) Int. Cl. H04L 12/56

(52) U.S. Cl. 370/394; 370/230

(57) ABSTRACT

A system and method for controlling a data call traffic frame in a mobile communication system assigns a sequence number to the traffic frame transmitted and received between the SDU and the PCF. This allows for a lost traffic frame to be easily detected. Because lost traffic frames can be detected and re-transmitted between the SDU and PCF, the lost traffic frame can be restored without using a radio section. Thus, transmission reliability between the SDU and PCF can be improved and a waste of radio resources can be prevented.

### BACKGROUND OF THE INVENTION

1. Field of the Invention

The present invention relates to communication systems, and more particularly to a system and method for controlling data call traffic in a mobile communication system.

2. Background of the Related Art

Mobile communication systems provide data service as well as voice service to meet demands of mobile subscribers. In order to provide data service to mobile subscribers, the mobile communication system must be adapted to interwork with a PDSN (Packet Data Serving Node) providing the data service.

FIG. 1 illustrates a network structure which provides data service to mobile subscribers. The network structure includes a mobile terminal 10 requesting a data service, a base station (BS) 20 wirelessly communicating with the mobile terminal, and a base station controller (BSC) 30 controlling the base station 20. The base station controller is connected to a PDSN 50, which provides a data service through a packet control function (PCF) 40. The base station controller is also connected to a mobile switching center (MSC) 60 which authenticates the mobile terminal and performs switching of a mobile call. Finally, an interworking function (IWF) 70 is connected to the mobile switching center.

The base station controller 30 includes a section/distribution unit (SDU) 31 for selecting a frame in the best state from traffic frames received from each base station, and a call control processor (CCP) 32 for managing a call control and mobility. The mobile switching center 60 includes a switch 62 for switching a mobile call. The PDSN 50 includes a server providing a data service. Operation of the mobile communication system for providing a data service to mobile subscribers will now be described. When the mobile terminal requests a data service, the mobile switching center 60 performs an authentication function on the mobile terminal. When the authentication is successful, the base station controller establishes a connection to the PDSN through the PCF 40 for a data service.

Data transmission and reception between the data service providing server and the mobile terminal is performed as traffic frames are transmitted and received through a line between the SDU 31 of the base station controller 30 and the PCF 40. More specifically, the traffic frame that the mobile terminal transmits to the PDSN 50 must pass through the base station 20, the SDU of the base station controller 30, and the PCF 40 before reaching the PDSN 50. Conversely, the traffic frame that the PDSN 50 transmits to the mobile terminal 10 passes through the PCF 40, the SDU 31 and the base station 20 to reach the mobile terminal.

If the traffic frame is lost after being transmitted from the mobile terminal, the PDSN requests retransmission of the lost traffic frame from the mobile terminal and receives the traffic frame. However, in the traffic frame transmission section of the data call, the SDU 31 and the PCF 40 do not perform a sequence control function. Thus, if a traffic frame is lost in the section between the SDU 31 and the PCF 40 due to an error generated in the line, the SDU and PCF cannot restore the lost traffic frame.

Another method for controlling the sequence of traffic frames between the SDU and PCF involves giving sequence numbers to traffic frames, which are then transmitted. If traffic frames are received out of order, they are simply aligned in sequence order based on their sequence numbers. Thus, if a traffic frame is lost between the SDU and PCF, the SDU and the PCF cannot restore the lost traffic frame. That is, the lost traffic frame can be restored only by request for re-transmission between the mobile terminal and the PDSN.

The aforementioned data call traffic frame control method therefore has at least the following problems. Since the re-transmission function is made through a radio section to restore the lost traffic frame in the section between the SDU and the PCF, radio resources are wasted. Also, a substantial possibility exists that because of the way the related art system is operated, defects in the line in the section between the SDU and the PCF may not be detected. This will degrade data service quality.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

An object of the present invention is to provide a system and method for controlling data call traffic frames in a mobile communication system in a manner that does not waste radio resources and is otherwise more efficient than other systems and methods for controlling data call traffic frames.

Another object of the present invention is to provide a system and method for controlling flow between an SDU and PCF by assigning a sequence number to traffic frames transmitted and received between the SDU and PCF.

Another object of this invention is to provide a system and method for controlling data call traffic frames in a mobile communication system, where defects or errors occurring in a line between an SDU and PCF may be consistently and reliably detected.

Another object of the present invention is to provide a system and method for controlling data call traffic frames in a mobile communication system, in which if a lost traffic frame is detected, re-transmission of the detected traffic frame is requested to restore the lost traffic frame using a sequence number of the traffic frame. This advantageously minimizes loss of traffic frames between an SDU and PCF, and because the lost traffic frame can be restored without using a radio section, waste of radio resources are minimized.

Another object of the present invention is to provide a method for controlling a data call traffic frame in a mobile communication system, in which if a traffic frame is lost between an SDU and PCF, a re-transmission request frame is generated, on the basis of which a frame loss rate can be provided, so that a link state between the SDU and PCF can be managed.

To achieve the foregoing objects and advantages, the present invention provides a method for controlling a data call traffic frame in a mobile communication system in which when a traffic frame is transmitted and received between an SDU and PCF and if a sequence order of the traffic frame received by a receiving party is not normal, the receiving party requests re-transmission of a traffic frame expected to be received from a transmitting party. The transmitting party then re-transmits the retransmission-requested traffic frame to the receiving party.

In the method for controlling a data call traffic frame in a mobile communication system, assuming that the transmitting party is an SDU and the receiving party is a PCF, when the retransmission request is transmitted from the PCF, the SDU re-transmits the retransmission-requested traffic frame to the PCF.

In the method for controlling a data call traffic frame in a mobile communication system, provided that the transmitting party is an SDU and the receiving party is a PCF, when the retransmission request is transmitted from the PCF, the SDU re-transmits the retransmission-requested traffic frame to the PCF.

In the method for controlling a data call traffic frame in a mobile communication system, provided that the transmitting party is a PCF and the receiving party is an SDU, when the retransmission request is transmitted from the SDU, the PCF re-transmits the retransmission-requested traffic frame to the SDU.

The present invention further provides a method for controlling a data call traffic frame in a mobile communication system, including: a step in which a traffic frame is transmitted from an SDU to a PCF and stored in a temporary buffer; a step in which a sequence order of the traffic frame is checked when the traffic frame is received by the PCF; a step in which if the sequence order is not normal, the PCF requests re-transmission of the traffic frame from the SDU; a step in which the temporary buffer of the SDU is searched according to the re-transmission request; and a step in which if the retransmission-requested traffic frame is in the temporary buffer, the traffic frame is re-transmitted from the SDU to the PCF.

The present invention further provides a method for controlling a data call traffic frame in a mobile communication system, including: a step in which a traffic frame is transmitted from a PCF to an SDU and stored in a temporary buffer; a step in which a sequence order of the traffic frame is checked when the traffic frame is received by the SDU; a step in which if the sequence order is not normal, the SDU requests re-transmission of the traffic frame from the PCF; a step in which the temporary buffer of the PCF is searched according to the re-transmission request; and a step in which if the retransmission-requested traffic frame is in the temporary buffer, the traffic frame is re-transmitted from the PCF to the SDU.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a construction of a related-art network for providing a data service to a mobile subscriber;

FIG. 2A illustrates a construction of a general data call traffic frame used in a mobile communication system;

FIG. 2B illustrates a construction of a header of the general data call traffic frame;

FIG. 3 illustrates a method for re-transmitting a traffic frame between an SDU and a PCF in accordance with the present invention;

FIG. 4 illustrates a processing method if re-transmission of a traffic frame is not possible between the SDU and the PCF; and

FIG. 5 illustrates a construction of an NAIL frame and a reset frame in accordance with the present invention.

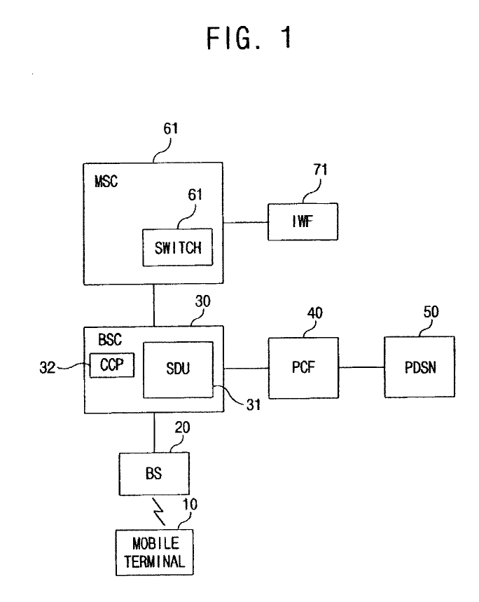

### DETAILED DESCRIPTION OF PREFERRED EMBODIMENTS

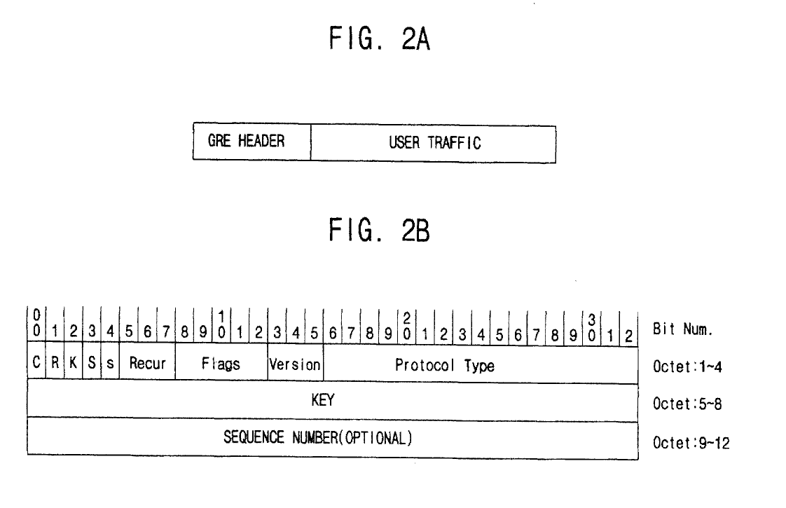

FIG. 2A shows one type of data call traffic frame which may be used in a mobile communication system in accordance with the present invention. The traffic frame includes a header 100 and a user traffic 150 which preferably conforms with a recommendation of a 3GPP2 (Third Generation Partnership Project 2) standard. The header may be a GRE header for interfacing with, for example, a generic routing encapsulation protocol (GRE).

FIG. 2B shows a construction of the header 100. The header includes a C field (Checksum Present) indicative of whether there is a checksum value for error check of a traffic frame, an R field (Routing Present) indicative of whether a routing is to be performed, a K field (Key Present) indicative of whether there is key information, an S field (Sequence Number Present) indicative of whether there is sequence number information, an s field (Strict Source Route Present) indicative of whether a source routing is to be performed, and a Recur field (Recursion Control) indicative of a repetitive control. The header also includes a flag field (Flags), a version field (Version; Version Number), a protocol type field (Protocol Type), a Key field indicative of a call identifier for identifying a traffic frame by calls, and a sequence number (Sequence Number) indicative of a sequence number.

Some exemplary values of the aforementioned fields will now be discussed. The K field may be set to ‘1’ for use, and when the K field has the value of ‘1’ it indicates that a call identifier recorded in the Key field is effective. The S field may be set to values of ‘0’ and ‘1’. In case of using a sequence number, the S field may be set to ‘1’ and an effective sequence number is recorded in the sequence number field. If the sequence number is not used, the S field is set to ‘0’. According to the present invention, the S field may be set to ‘1’ and an effective sequence number may be carried in the sequence number field, according to which flow control and retransmission of the traffic frame is made possible between the SDU and PCF.

temporary buffer with a predetermined capacity to temporarily store a traffic frame, and a PCF 300 has a second temporary buffer with a predetermined capacity. A case where the traffic frame is transmitted form the SDU 200 to the PCF 300 will first be described.

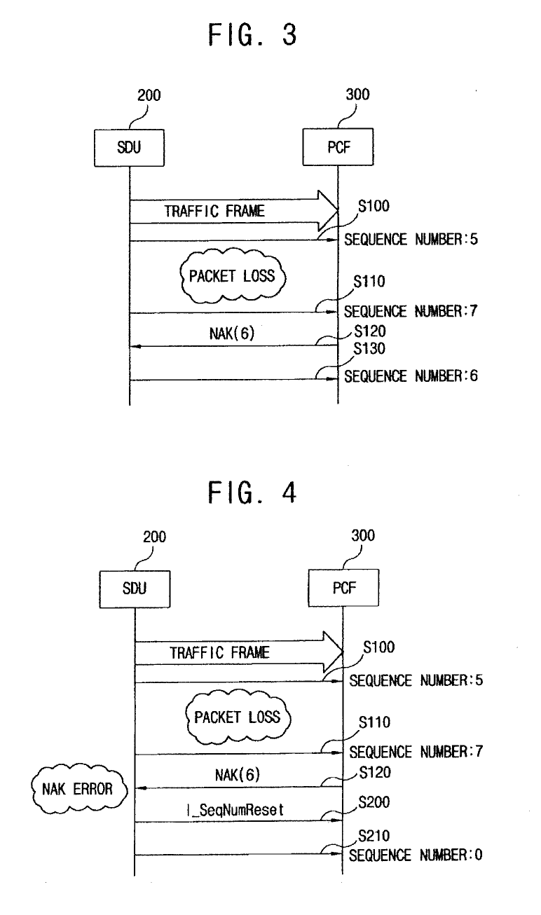

FIG. 3 shows steps included in a method for re-transmitting a traffic frame between an SDU and a PCF in accordance with one embodiment of the present invention. The SDU transmits a traffic frame for a data call to the PCF and also temporarily stores the transmitted traffic frame in the first temporary buffer. The traffic frame preferably has a format of a traffic frame illustrated in FIG. 2A, and S field of the header of the traffic frame is set to ‘1’ and a corresponding sequence number is carried n the sequence number field.

When the traffic frame is transmitted from the SDU, the PCF checks the sequence number of the received traffic frame to confirm whether the traffic frames are being received in the sequence number order (step S100). That is, if the currently received traffic frame has a sequence number ‘0’, the PCF expects to receive a next traffic frame with a sequence number ‘1’. For instance, if the previously received traffic frame has a sequence number ‘5’, the PCF expects to receive a traffic frame with a sequence number ‘6’ as a next traffic frame.

If, however, the next received traffic frame has a sequence number ‘7’, the PCF judges that a traffic frame with a sequence number ‘6’ has been lost in the course of transmission to the PCF. In this case, the PCF transmits a re-transmission request frame requesting re-transmission of the traffic frame with the sequence number ‘6’ to the SDU (steps S110 and S120). The retransmission request frame may be, for example, an NAIL frame.

When the SDU receives the NAK frame, the SDU checks whether a traffic frame with the sequence number included in the NAK frame exists in the first temporary buffer. If the first temporary buffer is full, the SDU deletes the first buffered traffic frame from the first temporary buffer. Thus, the traffic frames buffered in the first temporary buffer can be maintained in the first temporary buffer as long as the buffering time corresponding the size of the first temporary buffer. If the re-transmission requested transmission frame exists in the first temporary buffer, the SDU re-transmits the retransmission-requested traffic frame to the PCF (step S310). In this way, the lost traffic frame can be restored as a result of the re-transmission function between the SDU and PCF. Therefore, if a traffic frame is lost, it is not necessary to re-transmit the traffic frame between a mobile terminal and a PDSN to restore it, and thus re-transmission of the radio section can be significantly minimized.

FIG. 4 shows steps included in a method performed if re-transmission of a traffic frame is not possible between the SDU and the PCF. If a retransmission-requested traffic frame does not exist in the first temporary buffer, the SDU transmits a reset frame for requesting a sequence number initialization to the PCF. The reset frame may be, for example, an I_SeqNumReset frame. Accordingly, the next traffic frame transmitted has a sequence number ‘0’ (step S210). The operation performed when a traffic frame is transmitted from the PCF to the SDU may be the same as the case where the traffic frame is transmitted from the SDU to the PCF.

transmitted from the PCF to the SDU may be the same as the case where the traffic frame is transmitted from the SDU to the PCF.

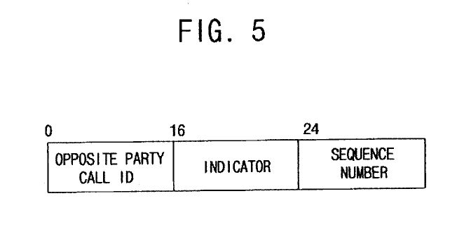

FIG. 5 shows one way in which a NAK frame and a reset frame may be constructed in accordance with the present invention. The NAK frame and reset frame may have the same format which includes an opposite-party call ID field indicative of a call ID of the opposite party, an indicator-field indicative of a type of a frame, and a sequence number field indicative of a sequence number.

The opposite party call ID field indicates a call ID of the side receiving the NAK frame or the reset frame. For example, in case of a NAK frame transmitted from the PCF to the SDU, the opposite party call ID field indicates a call ID of the SDU. In case of a NAK frame transmitted from the SDU to the SDU, the opposite party call ID field indicates a call ID of the PCF. In case of a reset frame transmitted from the PCF to the SDU, the opposite party call ID field indicates a call ID of the SDU. In case of a reset frame transmitted from the SDU to the PCF, the opposite party call ID field indicates a call ID of the PCF.

The indicator field indicates whether a frame is a NAIL frame or a reset frame. For example, a value ‘0’ of the indicator field indicates the NAK frame, while a value ‘1’ of the indicator field indicates the reset frame.

In case of the NAK frame, the sequence number field indicates a sequence number of a traffic frame expected to be re-transmitted.

When it is detected that a traffic frame has been lost between the SDU and PCF, the NAK frame is generated, which may be used as a data for judging whether an error exists in the line between the SDU and PCF.

According to the present invention, in transmitting and receiving a traffic frame for a data call between the SDU and the PCF, traffic frames are each assigned a sequence number, so that the frames can be received in a predetermined sequence order. Accordingly, a lost traffic frame can be easily detected, and because re-transmission of the detected traffic frame is performed without using the radio section, re-transmission in the radio section can be minimized.

The method for controlling a data call traffic frame in a mobile communication system of the present invention thus has many advantages.

By assigning a sequence number to the traffic frame transmitted and received between an SDU and PCF, a lost traffic frame can be easily detected. Also, since the lost traffic frame can be detected and re-transmitted in the section between the SDU and PCF of the transmission section of a traffic frame for a data call, the lost traffic frame can be restored even without using the radio section. Thus, transmission reliability in the section between the SDU and PCF can be improved and a waste of radio resources can be prevented. In addition, when a lost traffic frame between the SDU and PCF is detected, a retransmission request frame is generated based on which a frame loss rate can be provided, so that a link state between the SDU and the PCF can be managed.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for controlling data call traffic frames in a mobile communication system, comprising:
requesting retransmission of a traffic frame from a transmitting party if a sequence order of the traffic frame received by a receiving party is not in a predetermined order; and
re-transmitting the retransmission-requested traffic frame to the receiving party, wherein the traffic frame and retransmission-requested traffic frame are transmitted between an SDU and a PCF.

2. The method of claim 1, further comprising when the transmitting party is the SDU and the receiving party is the PCF:
transmitting the traffic frame from the SDU to the PCF; and
storing the traffic frame in a temporary buffer.

3. The method of claim 2, further comprising:
deleting a first buffered traffic frame from the first temporary buffer if the temporary buffer with a predetermined capacity is full.

4. The method of claim 2, wherein the re-transmission step comprises:
searching the temporary buffer according to the re-transmission request; and
re-transmitting the traffic frame from the SDU to the PCF if the retransmission requested traffic frame exists in the temporary buffer.

5. The method of claim 4, wherein the SDU maintains buffered traffic frames in the temporary buffer based on a predetermined buffering time corresponding to a size of the temporary buffer.

6. The method of claim 4, further comprising:
transmitting a reset frame for initializing a sequence number from the SDU to the PCF, if the retransmission-requested traffic frame does not exist in the temporary buffer.

7. The method of claim 6, wherein the SDU and the PCF initialize a sequence number of a next-arriving traffic frame with the reset frame.

8. The method of claim 7, wherein the reset frame comprises:
an opposite-party call ID field indicative of a call ID of a frame-receiving side;
an indicator field indicative of frame type; and
a sequence-number field including a sequence number.

9. The method of claim 4, wherein the retransmission request includes a NAK frame transmitted from the PCF to the SDU.

10. The method of claim 9, wherein the NAK frame comprises:
an opposite-party call ID field indicative of a call ID of the side receiving the NAK frame;
an indicator field indicative of frame type; and
a sequence-number field indicative of the sequence number of a traffic frame requested for re-transmission.

11. The method of claim 1, further comprising when the transmitting party is the PCF and the receiving party is the SDU:
transmitting the traffic frame from the PCF; and
storing the traffic frame in a temporary buffer.

12. The method of claim 11, further comprising:
deleting a first buffered traffic frame from the temporary buffer if temporary buffer with a predetermined capacity is full.

13. The method of claim 11, wherein the re-transmission step comprises:
searching the temporary buffer according to the re-transmission request; and
re-transmitting the traffic frame from the PCF to the SDU if the retransmission requested traffic frame exists in the temporary buffer.

14. The method of claim 13, wherein the PCF maintains the buffered traffic frames in the temporary buffer based on a predetermined buffering time which corresponds to a size of the temporary buffer.

15. The method of claim 13, further comprising:
transmitting a reset frame for initializing a sequence number from the PCF to the SDU, if the retransmission-requested traffic frame does not exist in the temporary buffer.

16. The method of claim 15, wherein the SDU and the PCF initialize the sequence number of a next-arriving traffic frame with the reset frame.

17. The method of claim 16, wherein the reset frame comprises:
an opposite-party call ID field indicative of a call ID of the side receiving the reset frame;
an indicator field indicative of frame type; and
a sequence-number field including a sequence number.

18. The method of claim 13, wherein the re-transmission request includes a NAK frame transmitted from the SDU to the PCF.

19. The method of claim 18, wherein the NAK frame comprises:
an opposite-party call ID field indicative of a call ID of the side receiving the NAK frame;
an indicator field indicative of frame type; and
a sequence-number field including a sequence number of a traffic frame requested for re-transmission.

20. A method for controlling data call traffic frames in a mobile communication system, comprising:
transmitting a traffic frame from an SDU to a PCF;
storing the traffic frame in a temporary buffer;
checking a sequence order of the traffic frame when the traffic frame is received by the PCF;
if the sequence order is not in a predetermined order, requesting retransmission of the traffic frame from the SDU;
searching the temporary buffer of the SDU according to the re-transmission request; and
if the retransmission-requested traffic frame is in the temporary buffer, re-transmitting the traffic frame from the SDU to the PCF.

21. The method of claim 20, further comprising:
transmitting a frame for initializing a sequence number from the SDU to the PCF, if the retransmission-requested traffic frame does not exist in the temporary buffer.

22. The method of claim 21, wherein the frame for initializing a sequence number and the frame for re-transmission request each comprise:
an opposite-party call ID field indicative of a call ID of a side receiving the frame;
an indicator field indicative of frame type; and
a sequence-number field including a sequence number.

23. A method for controlling data call traffic frames in a mobile communication system, comprising:
transmitting a traffic frame from a PCF to an SDU;
storing the traffic frame in a temporary buffer;
checking a sequence order of the traffic frame when the traffic frame is received by the SDU;
if the sequence order is not in a predetermined order, requesting re-transmission of the traffic frame from the PCF;
searching the temporary buffer of the PCF according to the re-transmission request; and
if the retransmission-requested traffic frame is in the temporary buffer, re-transmitting the traffic frame from the PCF to the SDU.

24. The method of claim 23, further comprising:
transmitting a frame for initializing a sequence number from the PCF to the SDU, if the retransmission-requested traffic frame does not exist in the temporary buffer.

25. The method of claim 24, wherein the frame for re-transmission request and the frame for initializing a sequence number each comprise:
an opposite-party call ID field indicative of a call ID of a side receiving the frame;
an indicator field indicative of frame type; and
a sequence-number field including a sequence number.

26. A method for managing data flow in a mobile communications system, comprising:
detecting that a traffic frame is received out of a predetermined order; and
transmitting a request for retransmission of the traffic frame, wherein traffic frame is transmitted by an SDU and received by a PCF.

27. The method of claim 26, wherein the detecting and transmitting steps are performed in the PCF.

28. The method of claim 27, further comprising:
receiving the retransmitted traffic frame in the PCF in response to the request.

29. The method of claim 26, wherein the detecting step is performed based on a sequence number included in the traffic frame.

30. A method for managing data flow in a mobile communications system, comprising:
receiving a request for retransmission of a traffic frame; and
retransmitting the traffic frame in response to said request, wherein the traffic frame is transmitted by an SDU and received by a PCF.

31. The method of claim 30, further comprising:
storing the traffic frame in a buffer.

32. The method of claim 31, wherein the retransmitting step includes:
searching the buffer to locate the traffic frame;
retransmitting the traffic frame from the SDU to the PCF if the traffic frame is located in the buffer.

33. The method of claim 31, wherein the retransmitting step includes:
searching the buffer to locate the traffic frame;
transmitting a reset frame for initializing a transmission sequence number if the traffic frame is not located in the buffer.

34. The method of claim 33, wherein the reset frame includes:
an opposite-party call ID field indicative of a call ID of a frame-receiving side;
an indicator field indicative of frame type; and
a sequence-number field.
